(19) United States
(12) Patent Application Publication
(10) Pub. No.: US 2026/0316581 A1
(43) Pub. Date: Oct. 15, 2026

(54) POWER SUPPLY DEVICE

(71) Applicant: DENSO CORPORATION, Kariya-city (JP)

(72) Inventor: Shinya Kato, Kariya-city (JP)

(73) Assignee: DENSO CORPORATION, Kariya-city (JP)

(21) Appl. No.: 19/693,974

(22) Filed: Jun. 1, 2026

Related U.S. Application Data
(63) Continuation of application No. PCT/JP2024/044733, filed on Dec. 18, 2024.

(30) Foreign Application Priority Data
Jan. 9, 2024 (JP) 2024-001489

(51) Int. Cl. B60L 3/00; B60L 3/04; B60L 58/12

(52) U.S. Cl. CPC B60L 3/0046; B60L 3/04; B60L 58/12; B60L 2240/547

(57) ABSTRACT

A power supply device includes battery packs connected in parallel to an external device, and a controller that communicates with the battery packs. Each battery pack includes battery cells and a monitoring device that detects the state of the battery cells and, in cooperation with the controller, controls the electrical connection with the external device according to the state of the battery cells. The monitoring device identifies the number of target battery packs, which are battery packs that remain electrically connected to the external device after control has been performed. The target monitoring device included in the target battery pack determines the fail-safe to be applied in an event that an abnormality subsequently occurs in a battery cell contained in the target battery pack, based on the number of target battery packs.

### CROSS REFERENCE TO RELATED APPLICATIONS

The present application is a continuation application of International Patent Application No. PCT/JP 2024/044733 filed on Dec. 18, 2024, which designated the U.S. and claims the benefit of priority from Japanese Patent Application No. 2024-001489, filed on Jan. 9, 2024. The entire disclosures of all of the above applications are incorporated herein by reference.

### TECHNICAL FIELD

The present disclosure relates to a power supply device.

### BACKGROUND

A power supply system includes a vehicle ECU, a first power storage device, and a second power storage device.

### SUMMARY

According to at least one embodiment, a power supply device includes battery packs connected in parallel to an external device. The power supply device has a controller that communicates with the battery packs. Each battery pack includes battery cells. Each battery pack includes a monitoring device that detects a state of the battery cells. The monitoring device, in cooperation with the controller, controls an electrical connection with the external device in accordance with the state of the battery cells. The monitoring device may acquire a target number that is a number of target battery packs. The target battery packs are, among the battery packs, electrically connected to the external device after the monitoring device and the controller perform the control of the electrical connection. A target monitoring device is the monitoring device included in a corresponding one of the target battery packs. The target monitoring device may determine, in accordance with the target number, a fail-safe operation. The fail-safe operation may be performed when an abnormality subsequently occurs in a battery cell of the battery cells included in the corresponding one of the target battery packs.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a power system including a power supply device according to a first embodiment.

FIG. 2 is a flowchart illustrating a fail-safe of the power supply device.

FIG. 3 is a flowchart illustrating a fail-safe of the power supply device.

FIG. 4 is a block diagram illustrating a power system including a power supply device according to a second embodiment.

### DETAILED DESCRIPTION

To begin with, examples of relevant techniques will be described.

A power supply system according to a comparative example includes a vehicle ECU, a first power storage device, and a second power storage device. The vehicle ECU is communicatively connected to the first power storage device and the second power storage device. The first power storage device includes a first current interrupting device, a first battery module, and a first BMU. The second power storage device includes a second current interrupting device, a second battery module, and a second BMU.

When there is a normal power storage device and an abnormal power storage device, the vehicle ECU permits current interruption for the abnormal power storage device. As a result, even if an abnormality occurs in one of the power storage devices, power supply to the vehicle can be continued by the other power storage device, thereby providing redundancy to the vehicle's power source. In addition, when all of the power storage devices are abnormal, the vehicle ECU prohibits current interruption for two or more of the power storage devices. This ensures that sufficient time is secured for the vehicle to stop safely.

In the configuration of the power supply system, based on the combination of normal and abnormal states of each power storage device, the supply and interruption of current to each power storage device are controlled so that at least one power storage device remains in the energized state. In the configuration of the power supply system, the fail-safe is determined as current interruption, and it is not possible to determine the fail-safe according to the number of battery packs currently connected to external devices.

In contrast to the comparative example, according to a power supply device of the present disclosure, a fail-safe can be determined based on the number of battery packs electrically connected to external devices.

According to one aspect of the present disclosure, a power supply device includes battery packs connected in parallel to an external device. The power supply device has a controller that communicates with the battery packs. Each battery pack includes battery cells. Each battery pack includes a monitoring device that detects a state of the battery cells. The monitoring device, in cooperation with the controller, controls an electrical connection with the external device in accordance with the state of the battery cells. The monitoring device acquires a target number that is a number of target battery packs. The target battery packs are, among the battery packs, electrically connected to the external device after the monitoring device and the controller perform the control of the electrical connection. A target monitoring device is the monitoring device included in a corresponding one of the target battery packs. The target monitoring device determines, in accordance with the target number, a fail-safe operation. The fail-safe operation is performed when an abnormality subsequently occurs in a battery cell of the battery cells included in the corresponding one of the target battery packs.

According to this configuration, based on the number of target battery packs electrically connected to the external device, the target monitoring device included in the target battery pack is capable of determining the subsequent fail-safe.

The reference numerals in parentheses in the appended claims indicate only a correspondence relationship with configurations described in the embodiment to be described later, and do not limit the technical scope in any way.

Hereinafter, embodiments for carrying out the present disclosure are described with reference to the drawings. In each embodiment, parts corresponding to the elements described in the preceding embodiments are denoted by the same reference numerals, and redundant explanation may be omitted. When only a part of a configuration is described in an embodiment, the other preceding embodiments can be applied to the other parts of the configuration.

In addition, not only the combination between portions explicitly described that the combination is possible in each embodiment, but also partial combinations between the embodiments, between the embodiment and the modification, and between the modifications can be made if there is no problem in the combination in particular even when not explicitly described.

### First Embodiment

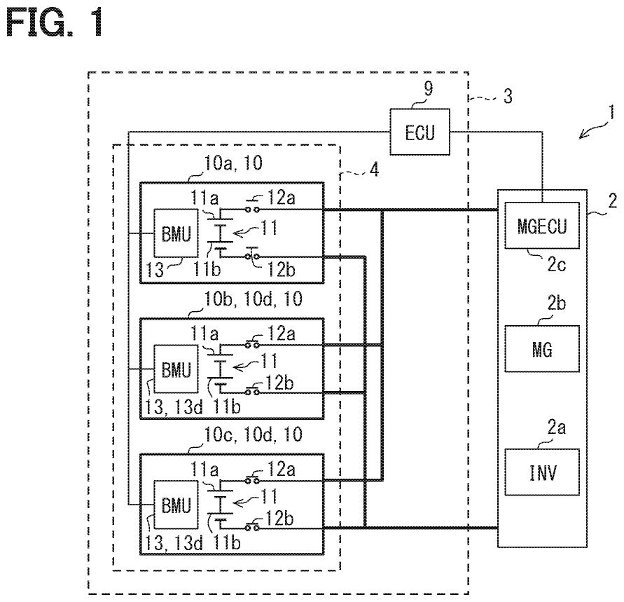

FIG. 1 is a block diagram illustrating a power system 1 including a power supply device 3 according to a first embodiment. As one example, the power system 1 is mounted in a vehicle and supplies power for driving the vehicle. It should be noted that the installation destination of the power system 1 is not limited to vehicles. As other examples, the power system 1 may be used in mobile computer devices such as mobile phones, laptop computers, and tablet computers. Alternatively, as another example, it may be installed in portable multimedia devices including digital cameras, video cameras, and audio/video playback devices.

In the following, the embodiment in which the power system 1 is mounted in a vehicle is mainly described as an example. The power system 1 includes an electric mechanism 2 that supplies power to drive wheels for driving the vehicle. The electric mechanism 2 may include an inverter circuit 2a, a rotary electric machine 2b such as a generator motor, a power transmission device such as a transmission, and the drive wheels of the vehicle. The electric mechanism 2 is installed in the vehicle as a main power unit of an electric vehicle, or as a power unit alongside an internal combustion engine in a hybrid vehicle. It should be noted that the electric mechanism 2 may also be referred to as an external device. In the drawings, the inverter circuit 2a is indicated as “INV” and the rotary electric machine 2b is indicated as “MG.”

The power system 1 is equipped with a power supply device 3 that supplies DC power to the electric mechanism 2. The power supply device 3 includes a battery module 4, with the electric mechanism 2 serving as its load. The power supply device 3 also includes a controller 9 that controls both the electric mechanism 2 and the power supply device 3. The power system 1 includes the power supply device 3 and the electric mechanism 2. It should be noted that the controller 9 is indicated as ECU in the drawings.

The controller 9 controls the electric mechanism 2 to enable the vehicle to travel properly. The controller 9 also manages the battery module 4. For example, the controller 9 controls relays, which is described later, at the time of starting and stopping the power system 1 in order to control the power supply to the electric mechanism 2. The controller 9 provides a drive control method for controlling the electric mechanism 2 according to charge state of the battery module 4. The controller 9 enables the battery module 4 to be charged by having the electric mechanism 2 function as a generator. Alternatively, the controller 9 provides a charging control method for controlling the power supply device 3 when the battery module 4 is charged from an external power source.

The controller 9 is electrically connected to an MG controller 2c of the electric mechanism 2 in order to control the inverter circuit 2a and the rotary electric machine 2b of the electric mechanism 2. Additionally, the controller 9 is electrically connected to a monitoring device 13 of battery packs 10 included in the battery module 4. The electrical connection between the controller 9 and the monitoring devices 13 is provided by a network connection that enables information communication. It should be noted that the MG controller 2c is indicated as “MGECU” in the drawings.

The controller 9 and the monitoring device 13 are control devices that operate by being powered from a low-voltage secondary battery installed in the vehicle. The controller 9 and/or the monitoring device 13 are provided by a microcomputer or a microcontroller equipped with a computer-readable storage medium. The storage medium stores a computer-readable program. The storage medium may be provided by a memory.

A program, when executed by the controller 9 and/or the monitoring device 13, enables these devices to function as intended. Furthermore, the program causes the controller 9 and/or the monitoring device 13 to function so as to execute the control method described in this specification. The method provided by the controller 9 and/or the monitoring device 13 may also be referred to as a functional block or module that achieves a predetermined function.

The battery module 4 includes the battery packs 10. In the figure, the battery packs 10a, 10b, and 10c are illustrated as an example. In the following description, when referring to a specific battery pack, reference numerals “10a”, “10b”, or “10c” are used, and when referring to any battery pack, reference numeral “10” is used. The battery packs 10 are connected in parallel to the load. The battery packs 10a, 10b, and 10c all have the same configuration.

The battery pack 10 includes a battery 11, a first power relay 12a, a second power relay 12b, and the monitoring device 13. The battery 11 is a high-capacity, high-voltage secondary battery capable of functioning as a power source for driving a vehicle. The battery 11 can be provided by a lithium-ion battery that supplies a voltage of several hundred volts. The battery 11 has battery cells.

In the figure, the battery cells 11a and 11b are illustrated as an example. The battery cell 11a and the battery cell 11b are connected in series. A positive electrode of the battery cell 11a is electrically connected to a positive electrode of the electric mechanism 2. A negative electrode of the battery cell 11a is electrically connected to a positive electrode of the battery cell 11b. A negative electrode of the battery cell 11b is electrically connected to a negative electrode of the electric mechanism 2.

The first power relay 12a is provided between the positive electrode of the battery cell 11a of each battery pack 10a, 10b, and 10c, and the electric mechanism 2. The first power relay 12a is a system relay on the positive electrode side in the power supply device 3. The second power relay 12b is provided between the negative electrode of the battery cell 11b of each battery pack 10a, 10b, and 10c, and the electric mechanism 2. The second power relay 12b is a system relay on the negative electrode side in the power supply device 3. The power relays 12a and 12b intermittently connect and disconnect a connection between the battery 11 and the electric mechanism 2.

The monitoring device 13 detects the state of the battery 11 in the battery pack 10 to which it belongs, and also controls the opening and closing of the power relays 12a and 12b. It is also possible for a single monitoring device 13 to monitor multiple battery packs 10. The monitoring device 13 detects the status of the battery pack 10, such as voltage, current, and temperature. Based on the detected status, the monitoring device 13 can determine whether the battery 11 being monitored is normal or abnormal. An abnormality in the battery 11 refers to conditions such as overcharging, overdischarging, or abnormal temperature. State information of each battery pack 10 is transmitted from each monitoring device 13 to the controller 9. The state information refers to information regarding whether the battery 11 is in a normal state or an abnormal state.

In response, control instructions for the power relays 12a and 12b are transmitted from the controller 9 to each monitoring device 13. As one example, a control instruction is an instruction that permits the electrical connection between the battery pack 10 containing the battery 11, which is in a normal state, and the electric mechanism 2, when the state of the battery 11 is normal. As another example, a control instruction is an instruction to disconnect the electrical connection between the battery pack 10 containing the abnormal battery 11 and the electric mechanism 2 when the state of the battery 11 is abnormal. As yet another example, a control instruction is an instruction issued when there is a voltage variation among the battery packs 10a, 10b, and 10c. More specifically, it is an instruction to disconnect the electrical connection between the battery pack 10, whose voltage deviates significantly from an average value of these packs, and the electric mechanism 2.

The monitoring device 13 is capable of controlling the power relays 12a and 12b to disconnect the electrical connection between the electric mechanism 2 and any battery pack 10 that is abnormal or whose voltage deviates significantly from the average value. It should be noted that, as described above, the battery 11 includes the battery cells 11a and 11b connected in series. The performance and characteristics of these multiple battery cells 11a and 11b differ from each other due to product variations. Therefore, as charging and discharging are repeated, the SOC (State of Charge) of each of the multiple battery cells 11a and 11b becomes different. Due to their nature, the battery cells 11a and 11b must have overdischarge and overcharge prevented. In other words, overdischarge and overcharge refer to an extreme decrease and an extreme increase in SOC, respectively.

A fact that the SOC of each battery cell 11a and 11b varies means that an extent to which each battery cell 11a and 11b reaches overdischarge or overcharge also varies. In order to accurately control the SOC of battery 11 so that it does not reach overdischarge or overcharge, it is necessary to equalize the SOCs of the multiple battery cells 11a and 11b. In other words, it is necessary to match the SOC of each of the multiple battery cells 11a and 11b with the SOC of battery 11, which is the total average of these cells. Due to such requirements, the monitoring device 13 performs not only a fail-safe processing described later, but also an equalization processing of battery cells 11a and 11b.

The control results of the power relays 12a and 12b by the monitoring device 13 are transmitted to the controller 9. In response to receiving the control results, the controller 9 transmits information on the number of battery packs 10 that are currently electrically connected to the electric mechanism 2 to the monitoring device 13 of each battery pack 10. Even after the power relays 12a and 12b are controlled by the monitoring device 13, the battery pack 10 that remains electrically connected to the electric mechanism 2 may be referred to as a target battery pack 10d. The monitoring device 13 included in the target battery pack 10d may be referred to as a target monitoring device 13d. The information on the number of target battery packs 10d may be referred to as target quantity information.

As described above, the monitoring device 13 is capable of determining whether the monitored battery 11 is normal or abnormal. In the target monitoring device 13d, it is determined that the battery 11 included in the target battery pack 10d is normal. Furthermore, the target quantity information is transmitted from the controller 9 to the target monitoring device 13d. The target monitoring device 13d is configured so that it can determine subsequent fail-safe actions in accordance with the target quantity information.

The monitoring device 13 is programmed to execute a fail-safe that restricts the operation of the target battery pack 10d in an event that an abnormality occurs in the target battery pack 10d, provided that the number of target units is equal to or less than a predetermined value. Additionally, the monitoring device 13 is programmed to execute the fail-safe that electrically disconnects only the target battery pack 10d in which an abnormality has occurred from the electric mechanism 2, in an event that the number of target units exceeds the predetermined value and an abnormality subsequently occurs in the target battery pack 10d. The predetermined value is, for example, one. It should be noted that the predetermined value is not limited to one. The predetermined value may be two or greater.

When electrically disconnecting the target battery pack 10d in which an abnormality has occurred from the electric mechanism 2, a restriction signal to limit the output of the rotary electric machine 2b is transmitted from the controller 9 to the MG controller 2c prior to the disconnection. The MG controller 2c restricts the output of the rotary electric machine 2b based on the restriction signal. Accordingly, an amount of electric current required in a power supply path between the battery pack 10 and the electric mechanism 2 can be reduced. As a result, the target battery pack 10d in which an abnormality has occurred can be safely disconnected from the electric mechanism 2.

Additionally, as a fail-safe measure when the number of target units is equal to or less than the predetermined number, a method of limiting charging to the battery 11 is employed. For example, during driving, charging of the battery module 4 is prohibited by preventing the electric mechanism 2 from functioning as a generator. By performing charging, the SOC (State of Charge) of the battery pack 10 gradually increases. By limiting charging before overcharging occurs, a time until the target battery pack 10d reaches a voltage at which it loses its battery performance is extended. It is possible to ensure sufficient time for the vehicle to come to a safe stop.

As another fail-safe measure when the target number is at or below the predetermined value, a method of limiting discharge from the target battery pack 10d is employed. By performing discharging, the SOC (State of Charge) of the battery pack 10 gradually decreases. By limiting the discharge of the target battery pack 10d when the target number is at or below the predetermined value, the reduction of the SOC of the target battery pack 10d can be reduced. It is possible to ensure sufficient time for the vehicle to come to a safe stop.

The monitoring device 13 sets threshold values so that the SOC of the target battery pack 10d does not become over-discharged or over-charged, and controls an amount of electrical energy entering and leaving the target battery pack 10d. As an example, the monitoring device 13 measures a current value at fixed intervals and estimates the SOC using a current integration method. The current integration method measures an amount of electrical energy entering and leaving the battery 11 by continuously measuring the charge and discharge current of the battery 11. Then, by adding or subtracting this value from an initial capacity, the SOC is estimated. The monitoring device 13 determines that overcharging has occurred if the estimated SOC or the battery cell voltage exceeds a predetermined upper limit, and determines that overdischarging has occurred if it falls below a predetermined lower limit.

The monitoring device 13 also includes a timer to measure a duration of charging and discharging, among other parameters. The monitoring device 13 determines whether the measurement time indicated by the timer has exceeded a preset time limit. By controlling the power input and output to the battery 11 before the measurement time exceeds the time limit, the monitoring device 13 can ensure that sufficient time is secured for the vehicle to come to a safe stop.

The electric mechanism 2 also has a function of generating an electric power using at least one of the rotational energy of the engine and the rotational energy of the wheels. The rotary electric machine 2b generates an alternating voltage through power generation. The AC voltage is converted into a DC voltage by an inverter. This direct current voltage is supplied to both the battery pack 10 and the electrical load.

The electrical load includes a general load and a protected load, which is more closely related to vehicle operation than the general load. The general load refers to in-vehicle devices such as seat heaters, blower fans, electric compressors, room lights, and headlights. These general loads have the characteristic that their supplied power does not need to be constant. The required amount of electric power for the general load varies according to user operations and other factors while in the vehicle.

The protected load includes devices such as an electric shift position system, an electric power steering (EPS), brakes (ABS), door locks, a navigation system, and an audio system. These protected loads require that the supplied power remains constant. The protected load has the characteristic of switching from the ON state to the OFF state when the supply voltage falls below a threshold voltage. The required amount of electric power for the protected load is always maintained above a certain level so that it can accommodate changes in vehicle operation.

A primary purpose of controlling the opening and closing of the power relay is to supply power from the rotary electric machine. The monitoring device 13 controls the power relays 12a and 12b based on command signals from the controller 9 when the power system 1 is in the driving state. The target monitoring device 13d controls the opening and closing of power relays 12a and 12b based on the operating state of the rotary electric machine 2b and the SOC of the battery pack 10. The target monitoring device 13d controls the opening and closing of the power relays 12a and 12b so that the supply voltage to the protected load does not fall below the threshold voltage. Accordingly, the risk of power supply to the protected load being interrupted can be reduced.

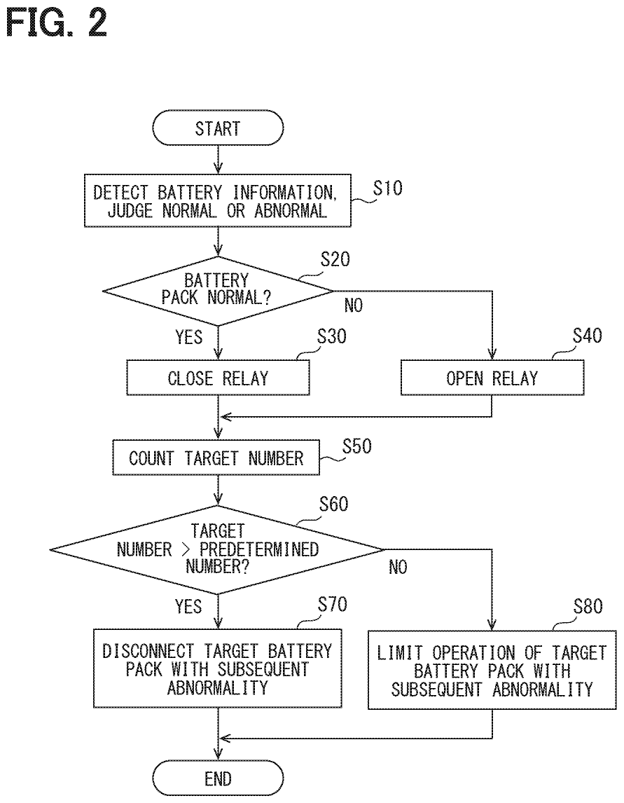

The fail-safe of the power supply device 3 will be explained below with reference to FIG. 2. A startup process is executed, for example, when the vehicle's power supply is turned on and the controller 9 starts control operations for driving the vehicle. In step S10, each monitoring device 13 detects the status of the battery 11, such as voltage, electric current, and temperature, and determines whether each battery pack 10 is in a normal or abnormal state. The status of each battery pack 10 determined in step S10 is transmitted from each monitoring device 13 to the controller 9.

In step S20, the controller 9 identifies the battery packs 10 that are in a normal state and those that are in an abnormal state, and outputs different control signals to each accordingly. For the battery packs 10 judged to be normal in step S20, in step S30, the controller 9 sends a signal to the monitoring device 13 to close power relays 12a and 12b. In step S30, the monitoring device 13 performs a process to close the power relays 12a and 12b for the battery packs 10 judged to be normal. For the battery packs 10 judged to be abnormal in step S20, in step S40, the controller 9 sends a signal to the monitoring device 13 to open power relays 12a and 12b. In step S40, the monitoring device 13 performs a process to open the power relays 12a and 12b for the battery packs 10 judged to be abnormal.

Next, in step S50, the controller 9 counts the target number, which is the number of battery packs 10 that are electrically connected to the electric mechanism 2 at that point in time. The number of battery packs 10 that are electrically connected refers to the number of battery packs 10 for which both power relays 12a and 12b in FIG. 1 are in the connected state. The target number information totaled in step S50 is transmitted to each monitoring device 13. In step S60, the target monitoring device 13d determines whether the target number exceeds the predetermined value.

When it is determined in step S60 that the target number is less than or equal to the predetermined value, in step S80, the target monitoring device 13d restricts the operation of the target battery pack 10d as the fail-safe for the target battery pack 10d. When it is determined in step S60 that the target number exceeds the predetermined value, in step S70, the target monitoring device 13d electrically disconnects the target battery pack 10d from the electric mechanism 2 as the fail-safe for the target battery pack 10d. It should be noted that, in both step S70 and step S80, the above-mentioned fail-safe is applied only to the target battery pack 10d in which an abnormality subsequently occurs. In step S70, when an abnormality subsequently occurs in some of the target battery packs 10d, only the target battery packs 10d in which the abnormality has occurred are electrically disconnected from the electric mechanism 2. The target battery packs 10d in which no abnormality has occurred maintain the electrically connected state with the electric mechanism 2. Furthermore, in step S70, when an abnormality subsequently occurs in all of the target battery packs 10d, none of the target battery packs 10d are electrically disconnected from the electric mechanism 2. At least one of the target battery packs 10d is maintained in the electrically connected state with the electric mechanism 2. The power supply device 3, after proceeding from step S70 or step S80 through END, starts the above-mentioned flow again. The above-mentioned flow is repeated until the vehicle's power supply is turned off and the controller 9 performs control to stop the vehicle.

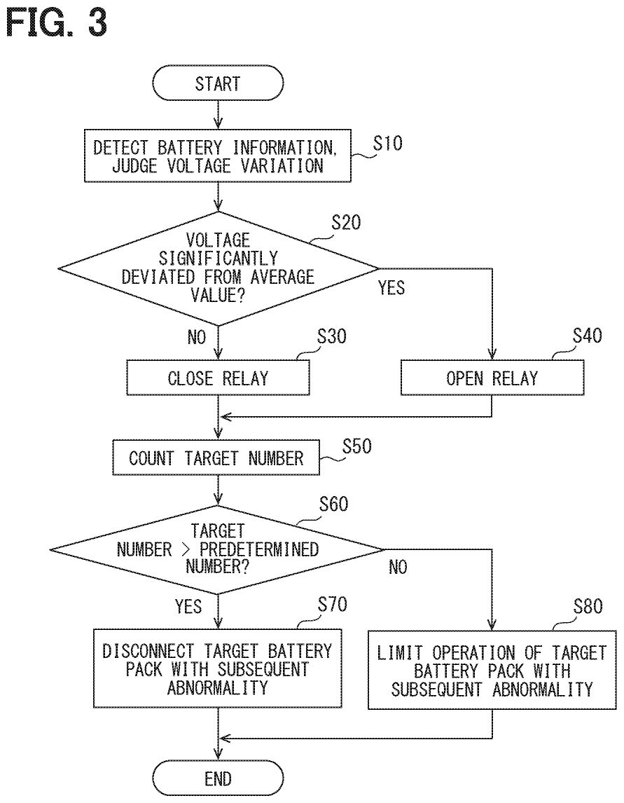

Furthermore, in step S10, each monitoring device 13 may, instead of determining the status of each battery pack 10, determine whether the voltage of each battery pack 10 deviates significantly from the average value. The fail-safe of the power supply device 3 will be explained with reference to FIG. 3. In step S20, the controller 9 identifies the battery pack 10 whose voltage deviates significantly from the average value and the other battery packs 10, and outputs different control signals to each.

For the battery packs 10 identified in step S20 as not deviating significantly from the average value, in step S30, the controller 9 transmits a signal to close the power relays 12a and 12b. For the battery packs identified in step S20 as deviating significantly from the average value, in step S40, the controller 9 transmits a signal to open the power relays 12a and 12b. Note that the flow after step S50 is similar, and thus its explanation is omitted.

### Actions and Effects

The power supply device 3 includes the battery packs 10 and the controller 9. The battery packs 10 are connected in parallel to the electric mechanism 2. The controller 9 communicates with the battery packs 10. Each battery pack 10 includes the battery 11 and the monitoring device 13. The monitoring device 13 detects the state of the battery 11. The monitoring device 13, in cooperation with the controller 9, controls the electrical connection to the electric mechanism 2 according to the state of the battery 11. The monitoring device 13 further determines the target number, which is the number of target battery packs. The target monitoring device determines the fail-safe to be applied in the event of an abnormality occurring in the battery 11 included in the target battery pack 10d, according to the target number. The target monitoring device is capable of determining the subsequent fail-safe according to the number of target battery packs.

The target monitoring device restricts the operation of the target battery pack when the number of target battery packs is less than or equal to the predetermined number and an abnormality subsequently occurs in the battery 11 included in the target battery pack. When the number of target battery packs is less than or equal to the predetermined number, the risk of power supply to the electric mechanism 2 being interrupted can be reduced.

When the number of target battery packs exceeds the predetermined number and an abnormality subsequently occurs in the battery 11 included in the target battery pack, the target monitoring device electrically disconnects only the target battery pack in which the abnormality has occurred from the electric mechanism 2. Even when the number of target battery packs exceeds the predetermined number, the risk of power supply interruption to the electric mechanism 2 can be reduced.

As the fail-safe when the number of target battery packs exceeds the predetermined number, after the power supply between the battery pack 10 and the electric mechanism 2 is restricted, the target monitoring device electrically disconnects only the target battery pack in which the abnormality has occurred from the electric mechanism 2. When electrically disconnecting from the electric mechanism 2, a restriction signal to limit the output of the rotary electric machine 2b is transmitted from the controller 9 to the MG control device 2c prior to the disconnection. The MG control device 2c restricts the output of the rotary electric machine 2b based on the restriction signal. Accordingly, the amount of electric current required in a power supply path between the battery pack 10 and the electric mechanism 2 can be reduced. Therefore, it is possible to safely disconnect the target battery pack in which an abnormality has occurred from the electric mechanism 2.

As the fail-safe measure when the number of target battery packs is equal to or less than the predetermined number, the target monitoring device restricts charging to the target battery packs. For example, during driving, charging of the battery module 4 from the electric mechanism 2 is prohibited. By restricting charging before the target battery pack becomes overcharged, the time until the target battery pack reaches a voltage at which it loses battery performance is extended. It is possible to secure sufficient time until the vehicle can be safely stopped.

As another fail-safe measure when the number of target battery packs is equal to or less than the predetermined number, the target monitoring device restricts discharging from the target battery packs. By restricting the discharge of the target battery pack, reduction of the SOC of the target battery pack can be reduced. It is possible to secure sufficient time until the vehicle can be safely stopped.

The fail-safe measure when the number of target battery packs is equal to or less than the predetermined number is implemented according to the SOC, voltage, or the restriction time of the target battery pack. As one example, the target monitoring device controls the amount of electric energy entering and leaving the target battery pack by setting a threshold so that the SOC of the target battery pack does not become overcharged. The target monitoring device restricts the amount of electric energy entering and leaving the target battery pack by setting a threshold so that the SOC of the target battery pack does not become over-discharged.

The monitoring device 13 controls the power relays 12a and 12b based on command signals from the controller 9. The target monitoring device controls the opening and closing of the power relays 12a and 12b based on the driving state of the rotary electric machine 2b and other factors. The target monitoring device controls the opening and closing of power relays 12a and 12b so that the supply voltage to the rotary electric machine 2b does not fall below the threshold voltage. The risk of power not being supplied to the electric mechanism 2 can be reduced.

The monitoring device 13 also includes the timer to measure a duration of charging and discharging, among other parameters. The monitoring device 13 determines whether the measurement time indicated by the timer has exceeded the preset limit time. Before the measurement time exceeds the limit time, the monitoring device 13 switches the battery pack 10 to restricted operation by controlling the power input and output to the battery 11. This makes it possible to ensure sufficient time for the vehicle to come to a safe stop.

### Second Embodiment

In the first embodiment, a configuration is described in which the battery module 4 includes the battery packs 10 having the same constituent components. Each of the battery packs 10 in the first embodiment is provided with the battery 11, the first power relay 12a, the second power relay 12b, and the monitoring device 13.

Each monitoring device 13 in the first embodiment detects the state of the battery 11 and controls the power relays 12a and 12b. The status of the battery 11 in each battery pack 10 is transmitted from each monitoring device 13 to the controller 9. In response, control instructions for the power relays 12a and 12b are transmitted from the controller 9 to each monitoring device 13. The results of the control of the power relays 12a and 12b by the monitoring device 13 are transmitted to the controller 9. Upon receiving the control results, the controller 9 counts the number of battery packs 10 currently connected to the electric mechanism 2.

The information on the number of battery packs 10 currently connected to the electric mechanism 2 is transmitted from the controller 9 to the monitoring device 13 of each battery pack 10. The target monitoring device 13d is configured so that it can determine subsequent fail-safe actions in accordance with the target quantity information.

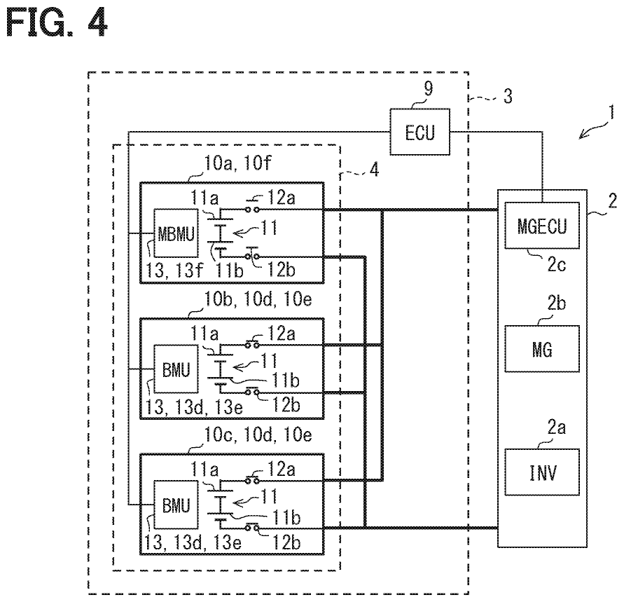

In contrast, in a second embodiment, a battery module 4 includes battery packs 10 containing different components. FIG. 4 is a block diagram illustrating a power system including a power supply device 3 according to the second embodiment. The battery packs 10 in the second embodiment includes a first battery pack 10e that is the same as in the first embodiment, and a second battery pack 10f that has a monitoring device 13 of a different type from that in the first embodiment. The monitoring device 13 included in the second battery pack 10f is a supervisory monitoring device 13f that manages the information transmitted from the monitoring device 13 provided in the first battery pack 10e.

Each monitoring device 13 in the second embodiment detects the state of the battery 11 and controls the power relays 12a and 12b. State information of the battery 11 in the first battery pack 10e is transmitted from each monitoring device 13e provided in the first battery pack 10e to the supervisory monitoring device 13f. In response, control instructions for the power relays 12a and 12b are transmitted from the supervisory monitoring device 13f to the monitoring devices 13e of the first battery pack 10e. The supervisory monitoring device 13f detects the state information contained in its own second battery pack 10f and controls the power relays 12a and 12b based on this information.

The control results of the power relays 12a and 12b by the monitoring device 13e are transmitted to the supervisory monitoring device 13f. Upon receiving the control results, the supervisory monitoring device 13f counts the number of battery packs 10 currently connected to the electric mechanism 2. The information regarding the number of battery packs 10 currently connected to the electric mechanism 2 is transmitted from the supervisory monitoring device 13f to the monitoring device 13e of the first battery pack 10e. The target monitoring device 13d is configured so that it can determine subsequent fail-safe actions in accordance with the target quantity information. It should be noted that, in the diagram, battery pack 10a is shown as having the supervisory monitoring device 13f, and the battery packs 10b and 10c are shown as having the target monitoring device 13d, but the configuration is not limited to this. When the supervisory monitoring device 13f itself serves as the target battery pack 10d, it determines subsequent fail-safe operations based on the target quantity information it possesses.

In this way, in the second embodiment, at least the functions of aggregating the target quantity information possessed by the controller 9 of the first embodiment and transmitting the target quantity information to each monitoring device 13 have been transferred to the supervisory monitoring device 13f. As a result, the same effects as the first embodiment can be provided.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A power supply device comprising:
battery packs connected in parallel to an external device; and
a controller configured to communicate with the battery packs, wherein
each of the battery packs includes:
battery cells; and
a monitoring device configured to detect a state of the battery cells and, in cooperation with the controller, control an electrical connection with the external device in accordance with the state of the battery cells,
the monitoring device is configured to acquire a target number that is a number of target battery packs, the target battery packs being, among the battery packs, electrically connected to the external device after the monitoring device and the controller perform the control of the electrical connection, and
a target monitoring device, which is the monitoring device included in a corresponding one of the target battery packs, is configured to determine, in accordance with the target number, a fail-safe operation to be performed when an abnormality subsequently occurs in a battery cell of the battery cells included in the corresponding one of the target battery packs.

2. The power supply device according to claim 1, wherein
the target monitoring device is configured to, as the fail-safe operation, restrict operation of the corresponding one of the target battery packs when the abnormality subsequently occurs in the battery cell included in the corresponding one of the target battery packs and when the target number is equal to or less than a predetermined number.

3. The power supply device according to claim 2, wherein
the target monitoring device is configured to, as the fail-safe operation, electrically disconnect only the corresponding one of the target battery packs in which the abnormality has occurred from the external device when the abnormality subsequently occurs in the battery cell included in the corresponding one of the target battery packs and when the target number is greater than the predetermined number.

4. The power supply device according to claim 3, wherein
the target monitoring device is configured to electrically disconnect only the target battery pack in which the abnormality has occurred from the external device after restricting current flow between the target battery pack and the external device.

5. The power supply device according to claim 2, wherein
the target monitoring device is configured to, as the fail-safe operation, restrict charging of the corresponding one of the target battery packs.

6. The power supply device according to claim 2, wherein
the target monitoring device is configured to, as the fail-safe operation, restrict discharging of the corresponding one of the target battery packs.

7. The power supply device according to claim 5, wherein
the target monitoring device is configured to perform the fail-safe operation based on at least one of a state of charge (SOC) of the corresponding one of the target battery packs, a voltage of the corresponding one of the target battery packs, and a preset time limit.

8. The power supply device according to claim 1, wherein
the target monitoring device is configured to determine the fail-safe operation based on the target number sent from the controller when the abnormality subsequently occurs in the battery cell included in the corresponding one of the target battery packs.

9. The power supply device according to claim 1, wherein
the monitoring device included in one of the battery packs is configured to function as a master monitoring device configured to supervise monitoring devices included in the remaining battery packs and to acquire the target number, and
the target monitoring device other than the master monitoring device is configured to determine the fail-safe operation based on the target number sent from the master monitoring device when the abnormality subsequently occurs in the battery cell included in the corresponding one of the target battery packs.
